(19) United States
(12) Patent Application Publication
(10) Pub. No.: US 2002/0026724 A1
(43) Pub. Date: Mar. 7, 2002

(54) Method of aligning micro structures using guides

(76) Inventors: Sung Moon, Seoul (KR); Tae Seok Sim, Seoul (KR); Hyung Hwan Oh, Seoul (KR)

Correspondence Address: BACON & THOMAS, PLLC, 625 Slaters Lane, 4th Floor, Alexandria, VA, 22314-1176, US

(21) Appl. No.: 09/749,783

(22) Filed: Dec. 28, 2000

(30) Foreign Application Priority Data
Sep. 7, 2000 (KR) 53217

(51) Int. Cl. G01D 21/00

(52) U.S. Cl. 33/645; 33/1 M

(57) ABSTRACT

A method of aligning microstructures using guides, which enables an align bonding technique, which is a technique in the Micro Electro Mechanical System (MEMS) field, with a cheap microscope of low power.

In a system including upper and lower structures having different patterns, array guides combined to four sides of the upper structure, and align guides positioned at four sides of the lower structure to form walls, which are regularly spaced apart, the method is to align the upper and lower structures with lowering the array guide into an align portion formed between the array guide and the align guide.

Though a 3D (3-dimensional) pattern such as a membrane structure or a trench structure made by a minute surface micro machining is formed at the structure, this method facilitates alignment without damage of the 3D pattern and without an expensive align device.

### BACKGROUND OF THE INVENTION

1. Technical Field

The present invention relates to a method of aligning micro structures using guides, and more particularly to a method of aligning micro structures using guides, which enables an align bonding technique, which is a technique in the Micro Electro Mechanical System (MEMS) field, with a cheap microscope of low power.

2. Description of the Prior Art

The align bonding technique is frequently used in the MEMS field such as an accelerometer, an angular speedometer, a micro actuator, etc. to align and bond two wafers or structures having different patterns at accurate positions.

Conventionally, a person should move and align structures to be contacted by using an aligner with seeing the structures using a microscope in state that surfaces of the structures are in contact.

However, this conventional technique generally employs a minute align key to align the structures to an upper, lower, right or left direction, which is not easy to align the structures accurately. Moreover, there is also a problem that very expensive device is required for ultra-minute align bonding.

Particularly, if there is a 3D (3-dimensional) pattern such as a membrane structure or a trench structure, which is made by a minute surface micro-machining and easy to be collapsed, at a contact surface of the structure, it is nearly impossible to align the structure because this 3D pattern is easily crumbled when aligning the structure to a certain direction.

### SUMMARY OF THE INVENTION

The present invention is designed to overcome the above problems of the prior art. An object of the invention is to provide a new method, which may apply the align bonding, one of MEMS techniques, to various fields more easily.

Another object of the present invention is to provide a method of aligning 3D micro structures using guides to ensure easier and more accurate align bonding, which was very complicate and required an expensive device, by making up for the prior art.

Still another object of the present invention is to provide a method of aligning 30 micro structures using guides, which has much better properties than the prior art but easy to deal with, and which may be applied to all MEMS fields using the bonding technique, particularly to a radio frequency (RF) MEMS to make a micro fluidics or a wave guide, a package process, a process required to combine a 3D structure such as LIGA with other components, a process to make a gyroscope or an acceleration sensor, an optical MEMS using a displace actuator, a bio MEMS, etc.

The present invention also has a characteristic in that it gives very easy processes and more accuracy than 1 micrometer because guides, recognizable by human eyes help the aligning process.

In order to obtain the above object, in a system including upper and lower structures having different patterns, array guides combined to four sides of the upper structure, and align guides positioned at four sides of the lower structure to form walls, which are regularly spaced apart, the present invention provides a method of aligning the upper and lower structures using the array guide and the align guide.

### BRIEF DESCRIPTION OF THE DRAWINGS

These and other features, aspects, and advantages of the present invention will become better understood with regard to the following description, appended claims, and accompanying drawings, in which like components are referred to by like reference numerals. In the drawings:

FIG. 1 is a perspective view showing a basic concept of a method of the present invention;

FIG. 2 shows an example of an array guide of the present invention;

FIG. 3 shows an example of an align guide of the present invention;

FIG. 4 is an enlarged view to illustrate an align method between the guides of FIG. 2 and FIG. 3; and

FIG. 5 shows an example to illustrate an align bonding technique using the guides of the present invention.

### DETAILED DESCRIPTION OF THE PREFERRED EMBODIMENT

Hereinafter, preferred embodiments of the present invention will be described in detail with reference to the accompanying drawings.

As to a basic concept of the present invention, a method of aligning upper and lower structures 10, 12 having different patterns to accurate positions is provided in which array guides are combined to four sides of the upper structure 10, an align portion 16 is formed between align guides 14, the align guides 14 being constituted by walls 14a, 14b at positions corresponding to the array guides 18, and the upper and lower structures 10, 12 are aligned by lowering the array guide 18 into the align portion 16 downwards, 3-dimensionally.

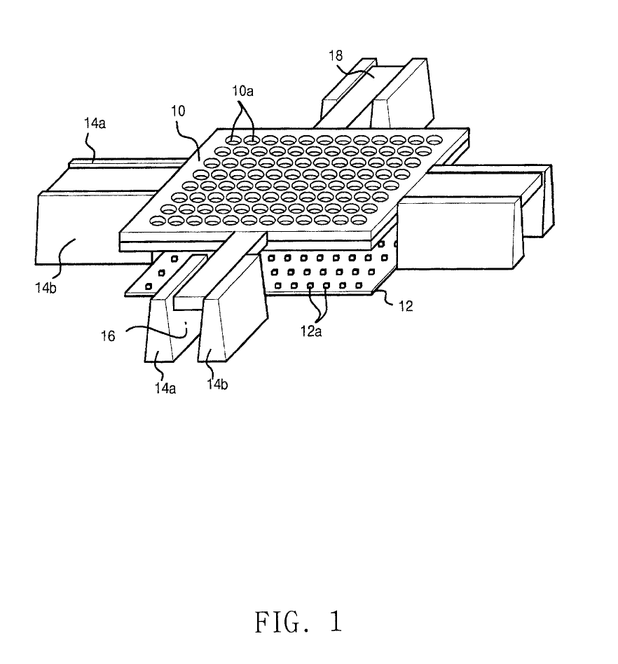

FIG. 1 shows a simple example of the present invention. Referring to FIG. 1, the array guides 18 combined to the upper structure 10 are positioned between the align guides 14 constituted by the walls 14a, 14b at positions corresponding to the array guides 18, to four sides of the lower structure 12. That is, FIG. 1 shows that the upper and lower structures 10, 12 are aligned using the guides 14, 18.

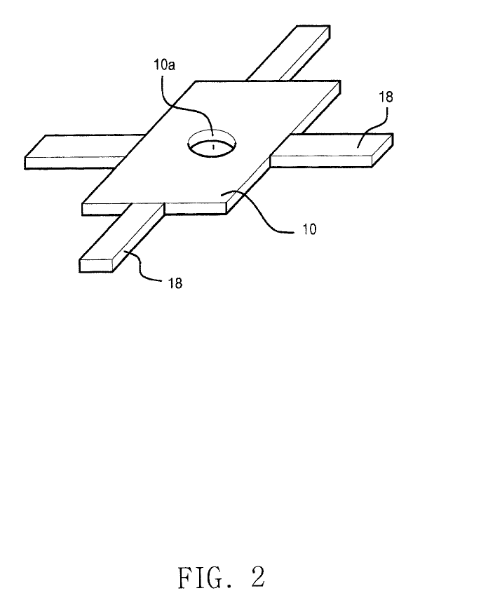

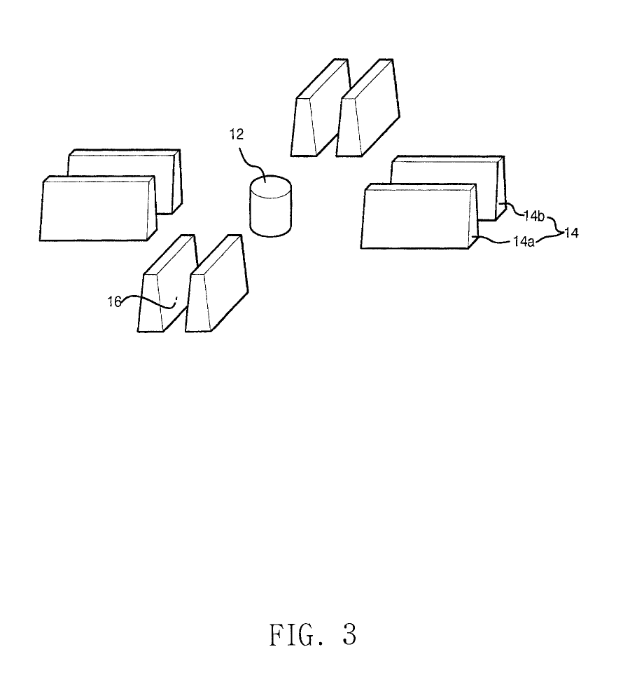

FIG. 2 and FIG. 3 show examples of the guides 14, 18. The align guide 14 and the array guide 18 may have various shapes only if they can be combined to each other.

In order to make the align guide 14 of the lower structure 14, a method of making a structure having a very high aspect ratio is employed. For example, this concept is possible by using photography using a thick photosensitizer, or a print technique or a sandblasting technique, which is used in a display field such as PDP (Plasma Display Panel), LED (Light Emission Diode), FED (Field Emission Display), etc.

The sandblasting technique means a technique for etching an object by using sand powder to form a diaphragm accurately.

In FIG. 3, the walls 14a, 14b of the align guide 14 are inclined to form a shape having a narrower upper space and a broader lower space therebetween.

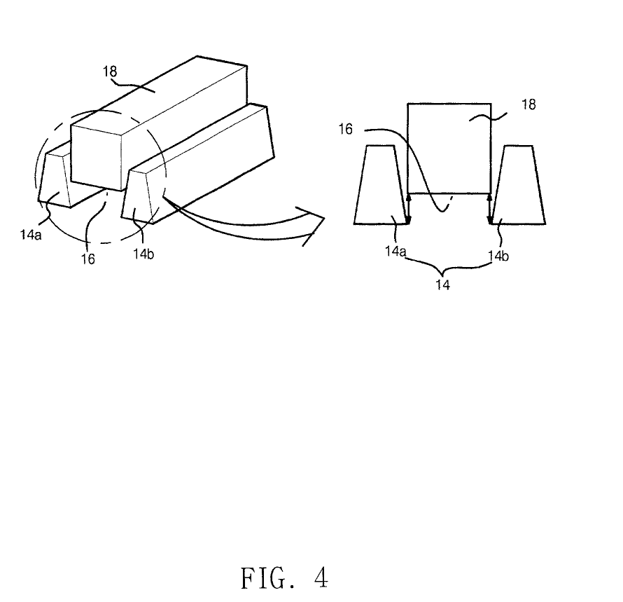

According to such shape of the walls 14a, 14b, the align portion 16, which is a space formed between the walls 14a, 14b, are shaped to have a broader upper portion and a narrower lower portion, opposite to the configuration of the walls 14a, 14b, as shown in FIG. 4. Therefore, this configuration of the align portion 16 ensures the array guide 18 to be easily inserted into the align portion 16 downward and to be fixed with the align portion 16 as the array guide 18 moves downward, when aligning the upper structure 10 by using the array guide 18. This facilitates alignment of the upper structure 10 and the lower structure 12.

At this time, if locating the align guide 14 at a higher position than a pattern 12a of the lower structure 12, damage of the pattern 12a due to any mistake may be prevented in advance because the upper structure 10 is guided from a position above the pattern 12a, though the pattern 12a is a 3D pattern easily collapsed.

Alignment of the structures are easier when using such characteristic of the guides 14, 18 because accuracy of the alignment is only required for the align guide 14 of the lower structure.

For more detailed description, in fact that a size of the array guide 18 is better as it is smaller than that of a real mask and accuracy of the alignment is higher only if an accurate size of the pattern is transferred only to the align guide, it is far more convenient to decide conditions of the align process.

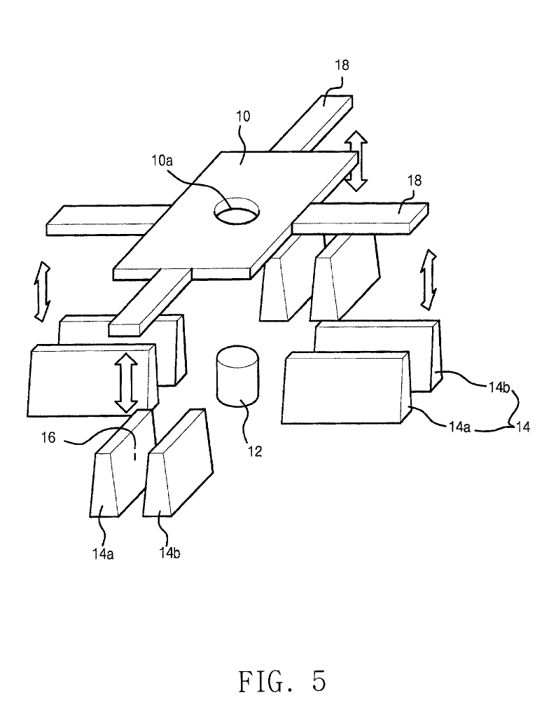

FIG. 5 shows that the upper and lower structures 10, 12 are contacted by the guides 14, 18. Referring to FIG. 5, it may be easily known that the structures are aligned in contact 3-dimensionally with moving downward.

As described above, though any film configuration using the surface micro-machining technique or other 3D patterns 12a are formed on the lower structure 12, the lower structure 12 may be aligned and combined without any damage of the 3D pattern. Moreover, because sizes of the guides 14, 18 depend on process conditions but are recognizable by human eyes, the structures can be easily aligned by using the guides without an expensive tools.

Though only 3D micro-structure are taken as an example here, aligning a wafer having patterns l0a, 12a is also possible with the align method described above and included within the scope of the present invention.

As described above, the present invention suggests a technique required combining or integrating 3D structures by suing the MEMS technology and gives better effects as follows in comparison to the prior art.

Conventionally, a person should move and align structures to be contacted by using an aligner with seeing the structures using a microscope in state that surfaces of the structures are in contact. Therefore, if there is a 3D (3-dimensional) pattern such as a membrane structure or a trench structure, which is made by a minute surface micro-machining and easy to be collapsed, at a contact surface of the structure, it is nearly impossible to align the structure and a very expensive device is required.

However, according to the present invention, the guides are as large as ones recognizable by the human eye, which ensures more accurate and easier alignment with inexpensive microscope of low power.

In particular, because the align guide guides the 3D pattern from its upper portion downwards, the present invention also gives an effect of preventing damage of the pattern due to any mistake in advance.

What is claimed is:

1. A method of aligning upper and lower structures having different patterns to correct positions, the method comprising the steps of:
combining array guides to four sides of the upper structure;
forming an align portion between align guides, the align guides being constituted by walls at positions corresponding to the array guides; and
aligning the upper and lower structures by lowering the array guide into the align portion.

2. The method as claimed in claim 1,
wherein the guides have bigger sizes than the patterns of the upper and lower structures.

3. The method as claimed in claim 1,
wherein the align guide is positioned higher than the pattern of the lower structure.

4. The method as claimed in claim 2,
wherein the align guide is positioned higher than the pattern of the lower structure.

5. The method as claimed in claim 1,
wherein the upper and lower structures are wafers.

6. The method as claimed in claim 1,
wherein the walls constituting the align guide are inclined to form a shape having a narrower upper space and a broader lower space therebetween.

7. The method as claimed in claim 1,
wherein the align guide and the array guide are correspondingly combined each other.

8. The method as claimed in claim 6,
wherein the align guide and the array guide are correspondingly combined each other.
